(19) United States
(12) Patent Application Publication
(10) Pub. No.: US 2016/0293018 A1
(43) Pub. Date: Oct. 6, 2016

(54) METHOD OF CONTROLLING FLEET OF DRONES

(71) Applicant: Korea University Research and Business Foundation, Seoul (KR)

(72) Inventors: Hwang Nam Kim, Seoul (KR); Seung Ho Yoo, Seoul (KR); Jong Tack Jung, Seoul (KR); Albert Yong Joon Chung, Seoul (KR); Ji Yeon Lee, Gyeonggi-Do (KR); Suk Kyu Lee, Seoul (KR); Kang Ho Kim, Busan (KR)

(73) Assignee: Korea University Research and Business Foundation, Seoul (KR)

(21) Appl. No.: 15/007,347

(22) Filed: Jan. 27, 2016

(30) Foreign Application Priority Data
Apr. 1, 2015 (KR) 10-2015-0046277

(51) Int. Cl. G08G 5/00

(52) U.S. Cl. CPC G08G 5/0043; G08G 5/0082

(57) ABSTRACT

Disclosed is a method of controlling a fleet of drones. A method in which a ground control station (GCS) controls a fleet of drones includes registering, by the GCS which is located on the ground, stores information about the drones, and controls the drones, all the drones constituting the fleet in a fleet list, configuring the fleet by synchronizing a physical position and a logical position for each of all the registered drones, controlling a form of the fleet based on a mission of the fleet or a peripheral environment having an influence on a flight of the fleet, and maintaining the fleet by immediately reflecting inclusion or departure in fleet information when the drone constituting the fleet is incorporated into or departs from the fleet.

### CROSS-REFERENCE TO RELATED APPLICATION

This application claims priority to and the benefit of Korean Patent Application No. 2015-0046277, filed on Apr. 1, 2015, the disclosure of which is incorporated herein by reference in its entirety.

### BACKGROUND

1. Field of the Invention

The present disclosure relates to a method of controlling a fleet of drones. More particularly, the present disclosure relates to a drone fleet control method of configuring a plurality of drones as a fleet and controlling the fleet.

2. Discussion of Related Art

Drones include all flight vehicles which are remotely controlled or fly according to prior information in a state in which nobody boards the vehicle such as an unmanned aerial vehicle (UAV), an unmanned plane, and an unmanned flight vehicle. A drone fleet refers to a group of drones for jointly processing one or more missions. That is, a plurality of drones may constitute the fleet so that a mission which cannot be accomplished by one drone may be jointly accomplished by the plurality of drones.

For example, when the plurality of drones are used for simple and convenient movement and delivery in physical distribution, the load is distributed into the drones constituting the fleet and a heavier weight than a weight capable of being carried by one drone may be carried by the drones. Also, the drones may stably lift a wide or large physical object which is difficult to balance. When the plurality of drones is used, it may more flexibly cope with the case in which one drone fails or falls.

On the other hand, when a fleet of information collection drones to be mainly used in an army or construction is configured, a limit of an individual drone whose flight time is limited may be overcome. That is, a limit of the drone in an amount of information collection according to time may be overcome. For example, in the case of information (for example, video information) influenced by light, information collected at different times can appear significantly different. When information is collected over a relatively long time, correct collection may not be performed. Accordingly, when a fleet of a plurality of drones is configured, the above-described problem may be solved because a large amount of information may be collected at the same time and it may more flexibly cope with the case in which one drone fails or falls.

Fleet flight technology in a multi-drone environment as described above is expected to have various advantages because a mission which cannot be accomplished by one drone may be jointly accomplished by the plurality of drones.

However, the fleet flight technology having the above-described advantages was not implemented outdoors or in a place where a complete environment is not installed and its related technology was not actively studied. The flight of a fleet has been partially performed, but only the flight of a fleet which flies in a small space of about one room has been performed in an initial research stage.

### SUMMARY OF THE INVENTION

The present document concerns a drone fleet control method of configuring a plurality of drones as a fleet and freely controlling the fleet.

Also, the present document is directed to provide a drone fleet control method of enabling a plurality of drones to find relatively mutual positions, configuring a drone fleet based on the relative positions, and controlling the fleet.

Also, the present document is directed to provide a drone fleet control method of detecting factors having an influence on a flight of a fleet and controlling a form of the fleet according to the factors.

Also, the present document is directed to provide a drone fleet control method of maintaining a fleet by immediately reflecting inclusion or departure of a drone constituting the fleet when a drone is incorporated into or departs from the fleet.

In some scenarios, there is provided a method in which a ground control station (GCS) controls a fleet of drones, the method including: registering, by the GCS which is located on the ground, stores information about the drones, and controls the drones, all the drones constituting the fleet in a fleet list; configuring the fleet by synchronizing a physical position and a logical position for each of all the registered drones; controlling a form of the fleet based on a mission of the fleet or a peripheral environment having an influence on a flight of the fleet; and maintaining the fleet by immediately reflecting inclusion or departure in fleet information when the drone constituting the fleet is incorporated into or departs from the fleet.

The configuring of the fleet may include estimating, by the GCS, the physical position of each of the registered drones; and synchronizing the physical position and the logical position for each of the registered drones within the fleet.

The estimating of the physical position may include receiving, by the GCS, a value of a sensor installed in each of the registered drones and estimating the physical position of each drone based on the sensor value.

The controlling of the form of the fleet may include detecting, by the GCS, a wind velocity around a position at which the fleet flies and determining a value of a distance between the drones constituting the fleet and a flight height of the drone based on the detected wind velocity.

The controlling of the form of the fleet may include determining an operating range of the entire fleet and the value of the distance between the drones constituting the fleet based on characteristics of the mission to be performed by the fleet.

The controlling of the form of the fleet may include controlling the drones to maintain a distance value by transferring the distance value between the drones determined based on the detected wind velocity or characteristics of the mission to the drones which measure a mutual distance through mutual exchange of sensor values in control of the distance between the drones.

The controlling of the form of the fleet may include predicting whether the fleet will collide with a geographical feature based on geographical information pre-stored in the GCS and an estimated flight path of the fleet and changing the form of the fleet to prevent a collision according to a prediction result.

The controlling of the form of the fleet may include controlling the form of the fleet based on a pre-stored risk function algorithm to indicate real-time flight environment information of the fleet by a numerical value and indicate a degree of risk for a current fleet form according to the numerical value.

The maintaining of the fleet may include receiving, by the GCS, a fleet inclusion request message from a first drone which is a new drone; and registering the first drone in a pre-stored fleet list.

The maintaining of the fleet may include periodically monitoring, by the GCS, whether a drone registered in the fleet list departs; and deleting the departed drone from the fleet list when the departure of the drone is detected.

In those or other scenarios, there is provided a method in which a master drone controls a fleet of drones, the method including: transmitting, by the master drone which is one of the drones constituting the fleet, a discovery message to all member drones constituting the fleet; configuring the fleet by receiving response messages from the member drones; controlling a form of the fleet based on a mission of the fleet or a peripheral environment having an influence on a flight of the fleet; and maintaining the fleet by immediately reflecting inclusion or departure in fleet information when a drone constituting the fleet is incorporated into or departs from the fleet.

The configuring of the fleet may include estimating, by the master drone, a physical position of each of the member drones; and synchronizing the physical position and the logical position for each of the registered drones within the fleet.

The estimating of the physical position may include exchanging, by the master drone, sensor values with the member drones, estimating relative distances from the member drones, and estimating physical positions of the member drones based on the relative distances.

The estimating of the physical position may include exchanging, by the master drone, sounds with the member drones and estimating relative distances from the member drones based on sound arrival times.

The controlling of the form of the fleet may include detecting, by the master drone, a wind velocity around a position at which the fleet flies and determining a value of a distance between the drones constituting the fleet and a flight height of the drone based on the detected wind velocity.

The controlling of the form of the fleet may include determining, by the master drone, an operating range of the entire fleet and the value of the distance between the drones constituting the fleet based on characteristics of the mission to be performed by the fleet.

The controlling of the form of the fleet may include controlling the drones to maintain a distance value by transferring the distance value between the drones determined based on the wind velocity detected by the master drone or characteristics of the mission to the drones which measure a mutual distance through mutual exchange of sensor values in control of the distance between the drones.

The controlling of the form of the fleet may include predicting whether the fleet will collide with a geographical feature based on geographical information pre-stored in the master drone and an estimated flight path of the fleet and changing a flight form of the fleet to a form by which the collision is prevented according to a prediction result.

The controlling of the form of the fleet may include controlling, by the master drone, the form of the fleet based on a pre-stored risk function algorithm to indicate real-time flight environment information of the fleet by a numerical value and indicate a degree of risk for a current fleet form according to the numerical value.

The maintaining of the fleet may include receiving, by the master drone, a fleet inclusion request message from a second drone which is a new drone; and registering the second drone in a pre-stored fleet list.

The maintaining of the fleet may include periodically monitoring, by the master drone, whether a drone registered in the fleet list departs; and deleting the departed drone from the fleet list when the departure of the drone is detected.

In those or other scenarios, there is provided a method of controlling a fleet of drones, the method including: registering, by a third drone which is any one of the drones constituting the fleet, all member drones constituting the fleet; configuring, by the third drone, the fleet by synchronizing a physical position and a logical position for each of the member drones; controlling a form of the fleet based on a mission of the fleet or a peripheral environment having an influence on a flight of the fleet; and maintaining the fleet by immediately reflecting inclusion or departure in fleet information when a drone constituting the fleet is incorporated into or departs from the fleet.

The registering and the configuring of the fleet may be iterated while all drones constituting the fleet select other drones until the member drones are registered.

The configuring of the fleet may include estimating, by the third drone, the physical position of each of the member drones; synchronizing the logical position and the physical position for each of the registered drones within the fleet; and sharing a synchronization result with all the member drones.

The estimating of the physical position may include exchanging, by the third drone, sensor values with the member drones, estimating relative distances from the member drones, and estimating physical positions of the member drones based on the relative distances.

The estimating of the physical position may include exchanging, by the third drone, sounds with the member drones and estimating relative distances from the member drones based on sound arrival times.

The controlling of the form of the fleet may include detecting, by the third drone, a wind velocity around a position at which the fleet flies, determining a value of a distance between the drones constituting the fleet and a flight height of the drone based on the detected wind velocity, and sharing the determined value of the distance between the drones constituting the fleet and the flight height of the drone with all the member drones.

The controlling of the form of the fleet may include determining, by the third drone, an operating range of the entire fleet and the value of the distance between the drones constituting the fleet based on characteristics of the mission to be performed by the fleet, and sharing the operating range of the entire fleet and the value of the distance between the drones constituting the fleet with all the member drones.

The controlling of the form of the fleet may include controlling the drones to maintain a distance value by transferring the distance value between the drones determined based on the wind velocity detected by the third drone or characteristics of the mission to the drones which measure a mutual distance through mutual exchange of sensor values in control of the distance between the drones.

The controlling of the form of the fleet may include predicting whether the fleet will collide with a geographical feature based on geographical information pre-stored in the third drone and an estimated flight path of the fleet and changing a flight form of the fleet to a form by which the collision is prevented according to a prediction result.

The controlling of the form of the fleet may include controlling, by the third drone, the form of the fleet based on a pre-stored risk function algorithm to indicate real-time flight environment information of the fleet by a numerical value and indicate a degree of risk for a current fleet form according to the numerical value.

The maintaining of the fleet may include receiving, by the third drone, a fleet inclusion request message from a fourth drone which is a new drone; authenticating, by the third drone, the fourth drone; sharing an authentication result with all member drones; receiving authentication results of all the member drones for the fourth drone; and transmitting a result message indicating an inclusion of the fourth drone to the fourth drone after the fourth drone is incorporated into the fleet when the third drone and all the other member drones approve the inclusion of the fourth drone in the fleet.

The maintaining of the fleet may include transferring, by a fifth drone desiring to depart from the fleet, a departure notification message of the fifth drone to peripheral drones; and receiving, by the fifth drone, departure confirmation messages from the peripheral drones receiving the departure notification message.

The maintaining of the fleet may include periodically monitoring, by the third drone, whether a drone registered in the fleet list departs; and deleting the departed drone from the fleet list when the departure of the drone is detected.

A problem occurring when errors of sensors installed in drones overlap during the flight of a fleet may be prevented in advance by enabling a plurality of drones to detect relatively mutual positions and configuring and controlling the fleet of the drones based on the relative positions. Also, a plurality of drones may be efficiently controlled by controlling a form of a fleet according to a factor having an influence on the flight of the fleet and immediately reflecting inclusion or departure of a drone constituting the fleet in fleet information when the drone is incorporated into or departs from the fleet. Thus, it may extend an application field of the drone. In particular, the present solution has an advantage in that a mission which is not accomplished by one drone may be successfully performed and a more reliable service may be provided.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings.

FIGS. 1A, 1B and 1C are diagrams illustrating configuration examples of a system for controlling a fleet of drones in a drone network to which the present solution is applied.

FIG. 2 is a schematic processing flowchart illustrating a method of controlling a fleet of drones.

FIGS. 3, 4 and 5 are schematic processing flowcharts illustrating a fleet configuration process.

FIGS. 6, 7, 8 and 9 are schematic processing flowcharts illustrating a changed structure reflection process.

### DETAILED DESCRIPTION

While the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms “first,” “second,” “A,” “B,” etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements.

The terminology used herein to describe embodiments of the invention is not intended to limit the scope of the invention. The articles “a,” “an,” and “the” are singular in that they have a single referent, however, the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, components, and/or combinations thereof but do not preclude the presence or addition of one or more other features, items, steps, operations, elements, components, and/or combinations thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, preferred embodiments according to the present invention will be described in detail with reference to the accompanying drawings. Throughout this specification and the claims, when a certain part includes a certain component, it means that another component may be further included not excluding other components unless otherwise defined.

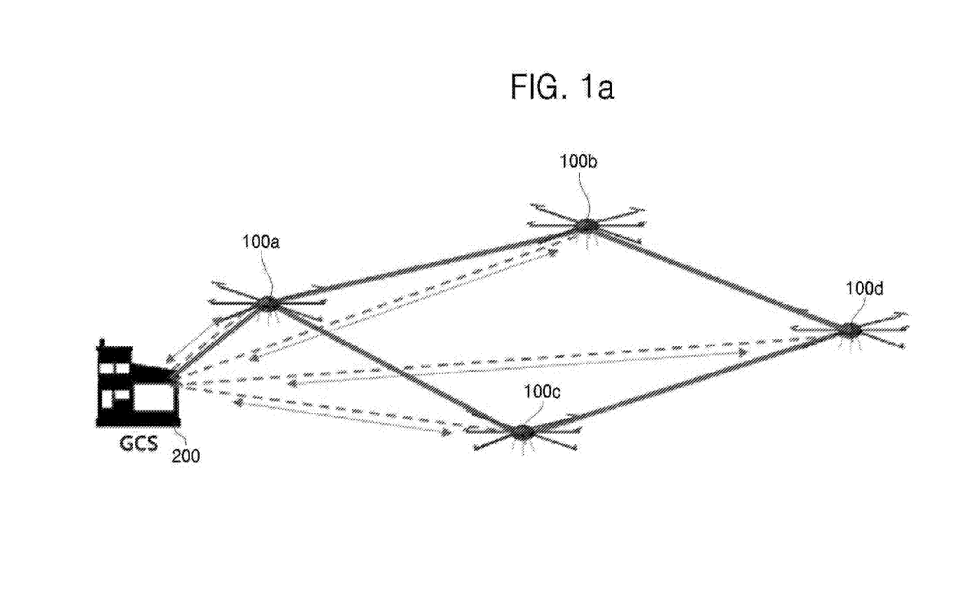

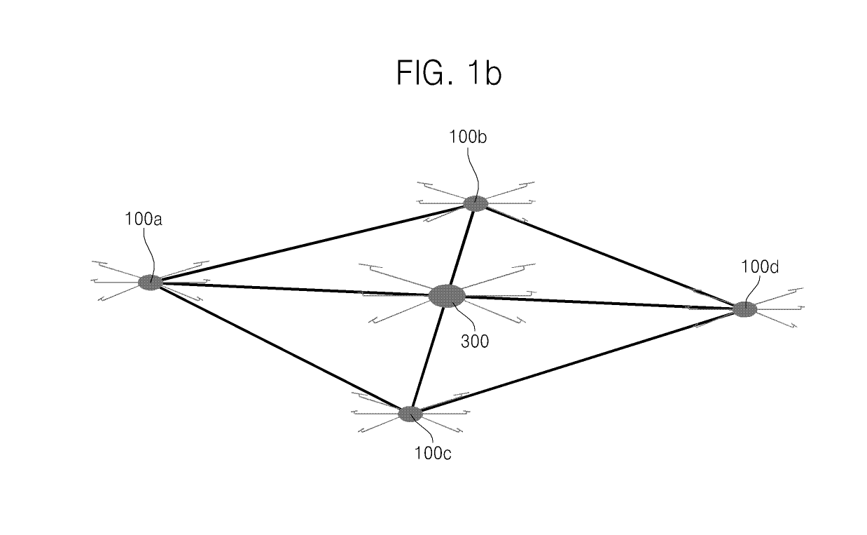

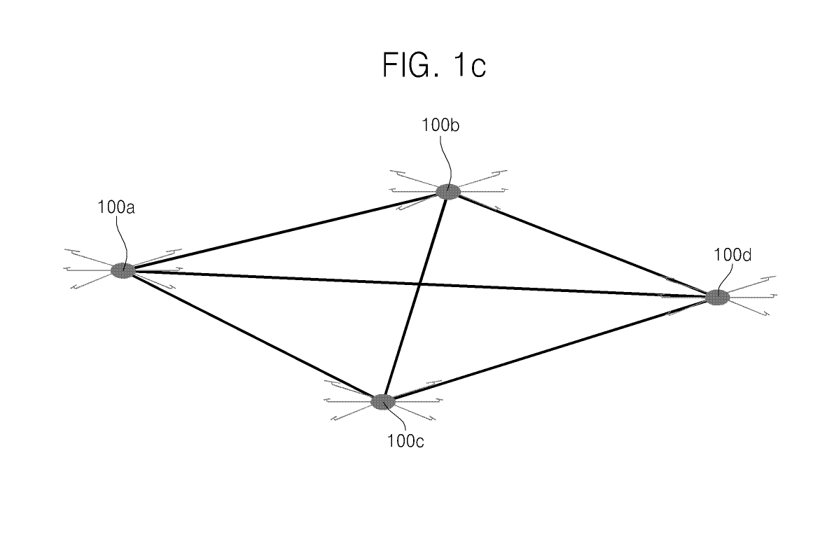

FIGS. 1A to 1C are diagrams illustrating configuration examples of a system for controlling a fleet of drones in a drone network to which the present solution is applied. FIG. 1A illustrates an example of a configuration of the system for controlling the fleet of the drones using a ground control station (GCS) according to a first exemplary scenario. FIG. 1B illustrates an example of a configuration of the system for controlling the fleet of the drones using a master drone according to a second exemplary scenarios. FIG. 1C illustrates an example of a configuration of the system for controlling the fleet of the drones by all member drones belonging to the fleet in a decentralized mode according to a third exemplary scenario.

Referring to FIG. 1A, the system for controlling the fleet of the drones using the GCS according to the first exemplary scenario is configured to include the GCS 200 and a plurality of drones 100a, 100b, 100c, and 100d constituting the fleet under control of the GCS 200. In the example of FIG. 1A, an example in which the four drones 100a, 100b, 100c, and 100d constitute the fleet and provide a network service under control of the GCS 200 is illustrated.

Referring to FIG. 1B, the system for controlling the fleet of the drones using the master drone according to the second exemplary scenario is configured to include the master drone 300 and a plurality of drones 100a, 100b, 100c, and 100d constituting the fleet under control of the master drone 300. In the example of FIG. 1B, an example in which the four drones 100a, 100b, 100c, and 100d constitute the fleet and provide a network service under control of the master drone 300 is illustrated.

Referring to FIG. 1C, the system for controlling the fleet of the drones by all member drones belonging to the fleet in the decentralized mode according to the third exemplary scenario is configured to include a plurality of drones 100a, 100b, 100c, and 100d constituting the fleet without a separate control means. In the example of FIG. 1C, an example in which the four drones 100a, 100b, 100c, and 100d constitute the fleet and provide a network service is illustrated.

A form of a fleet may freely change so that a drone does not collide with another peripheral drone, another environmental object, or a facility object when the plurality of drones are configured as a fleet and the drones constituting the fleet operate in units of fleets, and a changed structure may be immediately reflected when a structure of the fleet changes due to the inclusion or departure of a drone.

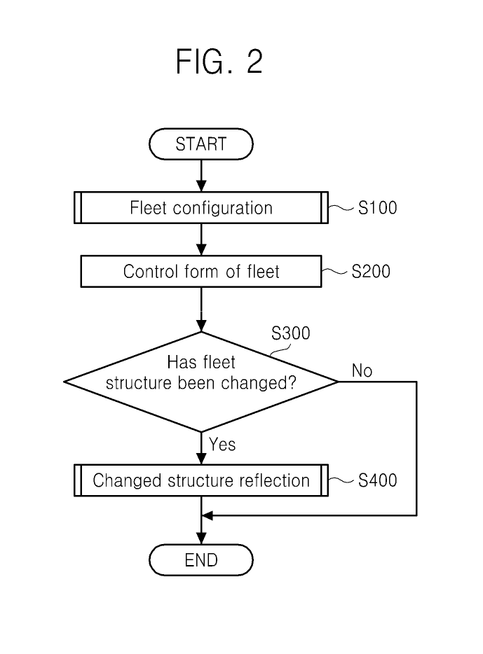

FIG. 2 is a schematic processing flowchart illustrating a method of controlling a fleet of drones according to the first to third exemplary scenarios. Referring to FIGS. 1A to 1C and 2, the drone fleet control method according to the first to third exemplary scenarios is as follows.

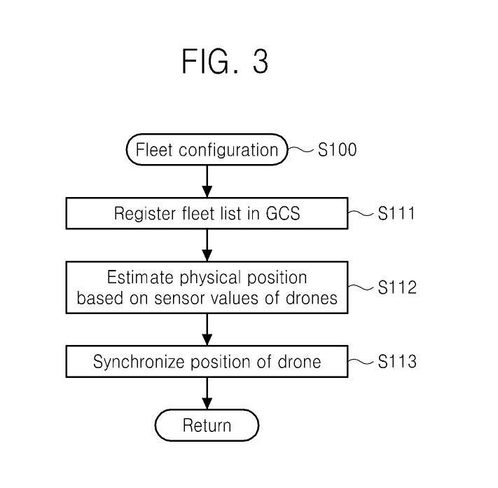

First, in step S100, a fleet including a plurality of drones is configured. That is, the GCS 200 of FIG. 1A, the master drone 300 of FIG. 1B, or the four drones 100a, 100b, 100c, and 100d constituting the fleet of FIG. 1C configures the fleet according to individually defined processing procedures. At this time, the GCS 200 of FIG. 1A, the master drone 300 of FIG. 1B, or the four drones 100a, 100b, 100c, and 100d constituting the fleet of FIG. 1C differently operate because of different operating environments. Specific examples of the above-described processing processes will be described in further detail with reference to FIGS. 3 to 5.

In step S200, the form is controlled based on a mission of the fleet configured in the above-described step S100 or a peripheral environment having an influence on the flight of the fleet. In the flight of the fleet, it is very important to control the form of the fleet. This is because a flight environment of the fleet may constantly change and the form of the fleet suitable for each situation may be provided according to a change in the environment. Accordingly, the GCS 200 of FIG. 1A, the master drone 300 of FIG. 1B, or at least one drone of the four drones 100a, 100b, 100c, and 100d constituting the fleet of FIG. 1C controls the form of the fleet according to a change in the following factors (for example, a peripheral environment, a geographical feature, a mission, a special situation, an algorithm, etc.)

1. Peripheral Environment

First, the drone needs to correct a form of a fleet according to the peripheral environment. For example, a possibility of a drone having a long distance departure within a short time becomes high in a situation in which a strong wind blows. If the control of the distance is not completely performed at high speed, a possibility of a collision becomes high and a possibility of mutual flight disturbance becomes high when a distance between the drones is excessively close. Therefore, the fleet of the drones is adapted to an environment to adjust the form. That is, when the strong wind blows as described above, the drones need to be further away from each other. In contrast, when the wind is weak, it is desirable for the drone to fly relatively high so that less noise is caused for people on the ground. A method such as a flight at a low height to compensate for low sensitivity of a camera-equipped drone due to darkness as well as risk may also be used.

For this, the GCS 200 of FIG. 1A, the master drone 300 of FIG. 1B, or at least one drone of the four drones 100a, 100b, 100c, and 100d constituting the fleet of FIG. 1C may detect a wind velocity around a position at which the fleet flies and determine a value of a distance between the drones constituting the fleet and a flight height of the drone based on the detected wind velocity. At this time, it is preferable that at least one drone of the four drones 100a, 100b, 100c, and 100d constituting the fleet of FIG. 1C share the determined value of the distance between the drones constituting the fleet and the flight height of the drone with all member drones. This is because the drones constituting the fleet perform decentralized control without a separate control means in the case of the fleet illustrated in FIG. 1C.

2. Geographical Features

In general, the geographical features include all of natural terrain, a forest, building and building interior, but are limited thereto. The fleet control according to the geographical features is performed when a situation occurs in which the fleet during the flight cannot enter a region due to current geographical features. That is, when the fleet is expected to collide with a geographical feature, the form needs to be modified according to the geographical feature. Because this limits a region in which the drone may actually move, form control may be implemented in accordance to the mission. For example, a situation in which the fleet needs to be formed in a long line when passing through a narrow space and is restored to the original fleet form when passing through a wide space or the like may be considered.

For this, the GCS 200 of FIG. 1A, the master drone 300 of FIG. 1B, and at least one drone of the four drones 100a, 100b, 100c, and 100d constituting the fleet of FIG. 1C may predict whether the fleet will collide with a geographical feature based on pre-stored geographical information and an estimated flight path of the fleet and changing a flight form of the fleet to a form by which the collision is prevented according to a prediction result.

On the other hand, because the control according to the geographical feature is performed when the fleet passes through a new geographical feature, an arrangement suitable for the new geographical feature may be necessary. For example, this situation does not occur in the fleet constituted of the same type of drones, but an arrangement suitable for installed hardware or software may be necessary in a fleet constituted of different types of drones. For example, in the case of movement from the outside of a building to the inside, a GPS device is ineffective but the usefulness of an infrared (IR) sensor increases. Accordingly, a drone first entering the building needs to be a drone having an indoor sensor such as an IR sensor rather than a drone provided with the GPS device. In this case, a first determination criterion is a possibility of a collision with an obstacle and the next determination criterion is an arrangement according to the sensor.

3. Mission

Drone form control according to the mission is a control scheme of selecting a fleet of a form having higher usefulness according to the nature of a mission. Because this control is for effectiveness and is less compulsory, the control has a lower priority than the control according to the geographical feature. On the other hand, the control according to the geographical feature does not frequently occur, but the control according to the mission frequently occurs. For example, in the case of the drones for providing a network, it may provide a service in a wider range when a distance between the drones is longer. When the distance is excessively long, a problem may be caused in connectivity of the network, speed, or the like. Accordingly, the distance is adjusted in consideration of both performance of the network and a service provision range. This tendency may be applied to a general case. Although the mission may be performed in a wide range when the drones are widely dispersed, quality and stability may be degraded. A relative distance between the drones is determined in consideration of importance of quality for the mission to be performed and an area to be covered. As another example, although further accurate and detailed information may be collected through a mutual information comparison when drones which collect environmental information fly at a mutually narrow distance, the range is narrowed. On the other hand, when the drones collect information at a long distance from each other, only relatively less accurate and superficial information may be collected, but information of a wider area may be collected. In addition, a change in an overall form or a position movement may be necessary to perform the mission. The entire direction and mobility of the fleet is basically determined by a relative distance. The position is adjusted by controlling the relative distance to be maintained and a detailed part such as rotation of the entire fleet is performed by each drone.

For this, the GCS 200 of FIG. 1A, the master drone 300 of FIG. 1B, or at least one drone of the four drones 100a, 100b, 100c, and 100d constituting the fleet of FIG. 1C may determine an operating range of the entire fleet and the value of the distance between the drones constituting the fleet based on the nature of the mission to be performed by the fleet. At this time, it is preferable that at least one drone of the four drones 100a, 100b, 100c, and 100d constituting the fleet of FIG. 1C shares the operating range of the entire fleet and the value of the distance between the drones constituting the fleet with all the member drones. This is because the drones constituting the fleet perform decentralized control without a separate control means in the case of the fleet illustrated in FIG. 1C.

At this time, the drones constituting the fleet measure a mutual distance by performing mutual exchange of sensor values. The measured distance is referred to as a relative distance. When the GCS 200 of FIG. 1A, the master drone 300 of FIG. 1B, and at least one drone of the four drones 100a, 100b, 100c, and 100d constituting the fleet of FIG. 1C determine a distance value and transfer the determined distance value to the drones, the drones control the form of the fleet so that the distance value is maintained.

4. Special Situation

The drones constituting the fleet basically move at the same speed. However, the case in which some drones need to move at a higher or lower speed than the fleet according to a characteristic of the fleet having an organic form may occur. For this, the drones moving in the fleet are constantly prevented from flying at a maximum speed. For example, if a relative position of one drone falls behind in a southerly direction when the fleet flies in a northerly direction, the drone needs to move in the northerly direction at a higher speed than a movement speed of the fleet. In this case, when the fleet flies at the maximum speed of the drone, the drone which moves at a slightly slow speed may be forced to depart. Accordingly, the fleet needs to constantly move in consideration of a relative speed.

5. Algorithm

On the other hand, a preset control algorithm may be applied so as to actually utilize the above-described schemes. For example, the GCS 200 of FIG. 1A, the master drone 300 of FIG. 1B, and at least one drone of the four drones 100a, 100b, 100c, and 100d constitute the fleet of FIG. 1C control the form of the fleet based on a pre-stored risk function algorithm to indicate real-time flight environment information of the fleet by a numerical value and indicate a degree of risk for a current fleet form according to the numerical value. That is, the GCS 200 of FIG. 1A, the master drone 300 of FIG. 1B, and at least one drone of the four drones 100a, 100b, 100c, and 100d constituting the fleet of FIG. 1C need to adjust the fleet so that the risk function does not exceed a given numerical value. At this time, the risk function considers a collision possibility as a risk element of the highest priority. When the drones have a high collision possibility, they need to fly at further distances from each other. For this, the risk function needs to change according to a situation, but information included in the risk function roughly includes a wind velocity, a flight speed, a form and size of a drone, accuracy of a sensor, a value update speed, and the number of peripheral drones. Also, the risk function is divided into two parts such as an external element and an internal element. The external element is used to indicate a current degree of risk and the internal element determines an allowable range of a value of the risk function. As the risk element increases, the value of the risk function increases. When the value of the risk function is greater than a proper level, a numerical value of the risk function is reduced by adjusting a speed, a degree at which a value of a sensor is updated, a distance between drones, or the like as an element capable of being controlled by the drone.

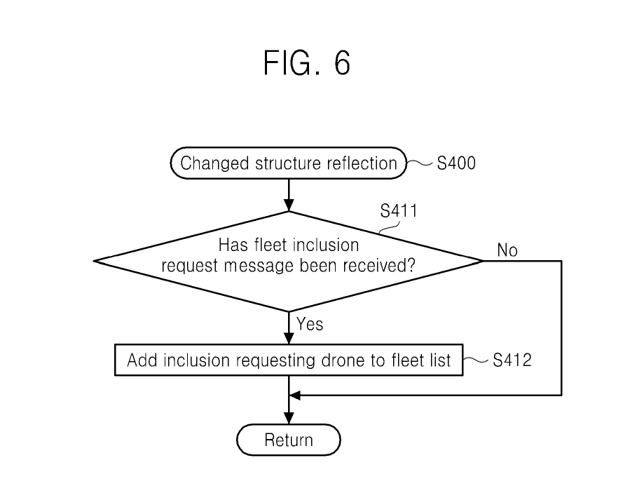

When the form of the fleet is controlled as described above, it is determined whether a structure of the fleet changes in step S300 and a changed structure is reflected in the fleet when the structure of the fleet changes, for example, when a new drone is incorporated into the existing fleet or a drone belonging to the existing fleet departs, in step S400. That is, each of the GCS 200 of FIG. 1A, the master drone 300 of FIG. 1B, and at least one drone of the four drones 100a, 100b, 100c, and 100d constituting the fleet of FIG. 1C detects a change in the fleet structure according to individually defined processing procedures and maintains the fleet by immediately reflecting the changed structure in the fleet information. At this time, the GCS 200 of FIG. 1A, the master drone 300 of FIG. 1B, and at least one drone of the four drones 100a, 100b, 100c, and 100d constituting the fleet of FIG. 1C perform different operations because an operating environment is different. A specific example of each processing process will be described in further detail with reference to FIGS. 6 to 9.

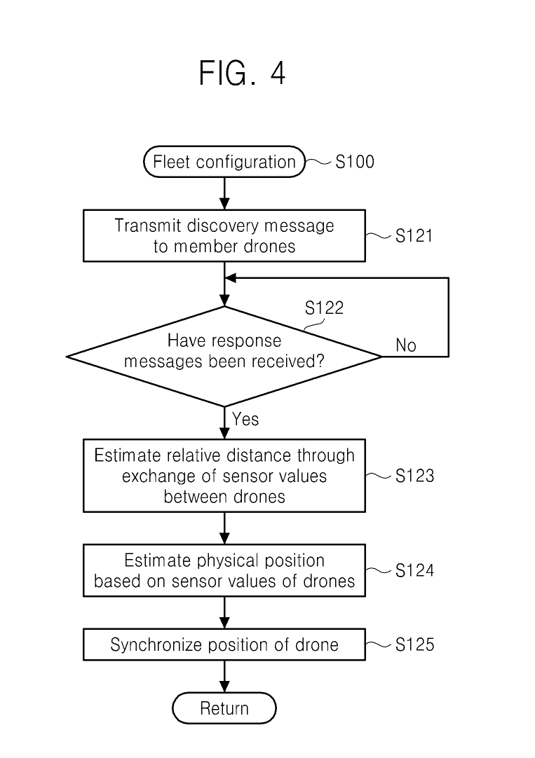

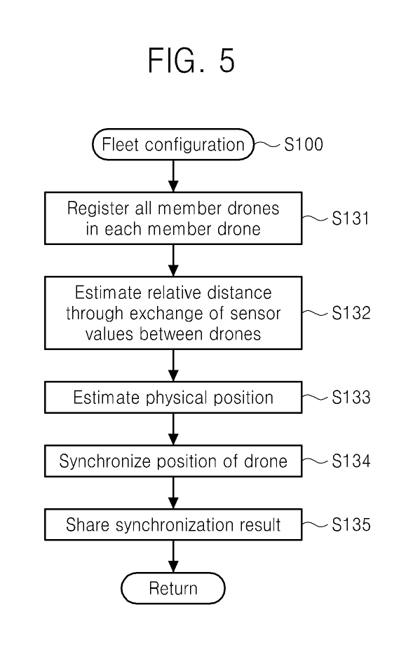

FIGS. 3 to 5 are schematic processing flowcharts illustrating the fleet configuration process of step S100 according to the first to third exemplary scenario. FIG. 3 illustrates an example of a processing process in which the GCS 200 of FIG. 1A configures a fleet according to the first exemplary scenarios, FIG. 4 illustrates an example of a processing process in which the master drone 300 of FIG. 1B configures the fleet according to the second exemplary scenario. FIG. 5 illustrates an example of a processing process in which one drone of the four drones 100a, 100b, 100c, and 100d constituting the fleet of FIG. 1C configures the fleet according to the third exemplary scenario.

Referring to FIGS. 1A and 3, the GCS 200 registers all drones constituting the fleet in a fleet list in step S111. For this, each drone is individually paired with the GCS 200.

In step S112, the GCS 200 estimates a physical position of each of the registered drones. For this, the GCS 200 may receive values of sensors installed in the registered drones and estimate physical positions of the drones based on the values of the sensors.

In step S113, the estimated physical position and a logical position for each of all the registered drones within the fleet are synchronized.

In the fleet of a centralized control scheme based on the GCS 200, the drones are in contact with the GCS 200 to obtain information about the fleet and many applications are possible because information about all the drones is collected in the GCS 200 having a high calculation capability. However, each drone need not directly communicate with the GCS 200 and may be indirectly connected to the GCS 200 by communicating with a drone directly connected to the GCS 200. On the other hand, because the GCS 200 is limited to being on the ground, it does not have the mobility of the drone.

Referring to FIGS. 1B and 4, the master drone 300 transmits a discovery message to all member drones in step S121.

In step S122, it is determined whether response messages are received from all the member drones.

When it is determined that the response messages are received from all member drones in step S122, the master drone 300 exchanges sensor values with the member drones and estimates relative distances from the member drones in step S123. For this, it is preferable that the master drone 300 exchanges sounds with all the member drones and estimate the relative distances from the member drones based on sound arrival times.

In step S124, physical positions of the member drones are estimated based on the relative distances. In step S125, the logical position and the physical position for each of the registered drones within the fleet are synchronized.

The centralized control scheme based on the master drone as described above has an advantage in that the fleet of the drones may move without being fixed to some region. On the other hand, because the master drone does not have calculation/processing capability due to a limitation in weight, size, or a form, the master drone does not perform complex calculation. Accordingly, the fleet of the form as described above requires high mobility and a wide mobility range, but the fleet is very suitable when only low calculation capability in finality is required.

Referring to FIG. 1C and 5, the four drones 100a, 100b, 100c, and 100d constituting the fleet of FIG. 1C register all member drones in step S131. For example, the drone 100a registers the drones 100b, 100c, and 100d, the drone 100b registers the drones 100a, 100c, and 100d, the drone 100c registers the drones 100a, 100b, and 100d, and the drone 100d registers the drones 100a, 100b, and 100c.

In step S132, each drone estimates relative distances by exchanging sensor values with the remaining drones. For example, the drone 100a estimates the relative distances from the drones 100b, 100c, and 100d by exchanging sensor values with the drones 100b, 100c, and 100d. The drone 100b estimates the relative distances from the drones 100a, 100c, and 100d by exchanging sensor values with the drones 100a, 100c, and 100d. The drone 100c estimates the relative distances from the drones 100a, 100b, and 100d by exchanging sensor values with the drones 100a, 100b, and 100d. The drone 100d estimates the relative distances from the drones 100a, 100b, and 100c by exchanging sensor values with the drones 100a, 100b, and 100c. At this time, the sensor value exchanged between the drones is related to sound and it is preferable to estimate the relative distances from the drones based on sound arrival times.

In step S133, each of the drones 100a, 100b, 100c, and 100d estimates physical positions of the member drones based on the relative distances from the remaining member drones.

In step S134, each of the drones 100a, 100b, 100c, and 100d constitutes the fleet by synchronizing a physical position and a logical position for each of the remaining member drones.

In step S135, a synchronization result is shared with all the member drones. For this, each drone transfers its own synchronization result to the remaining member drones.

As a form in which each drone stores fleet information, a fleet of a decentralized control scheme without a separate control means has high flexibility, but has disadvantages of complex implementation and significant performance constraints. That is, each drone needs to have information about all the drones within the fleet and may solve only an embarrassing parallel problem having low connectivity between drones in achieving the purpose. However, because there is no principal agent, a possibility of occurrence of a large problem due to an abrupt failure or drop is low.

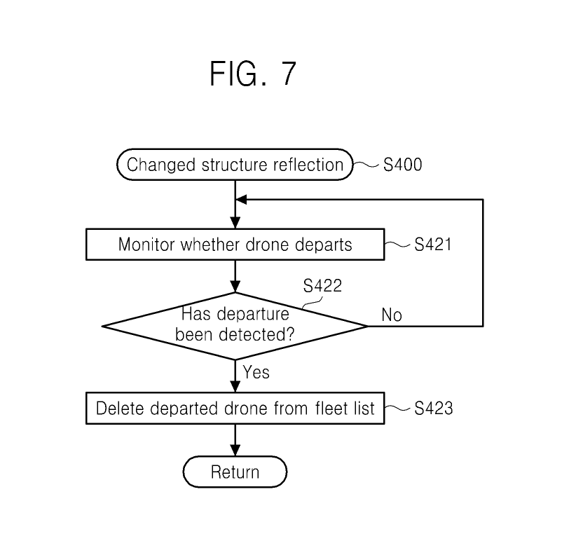

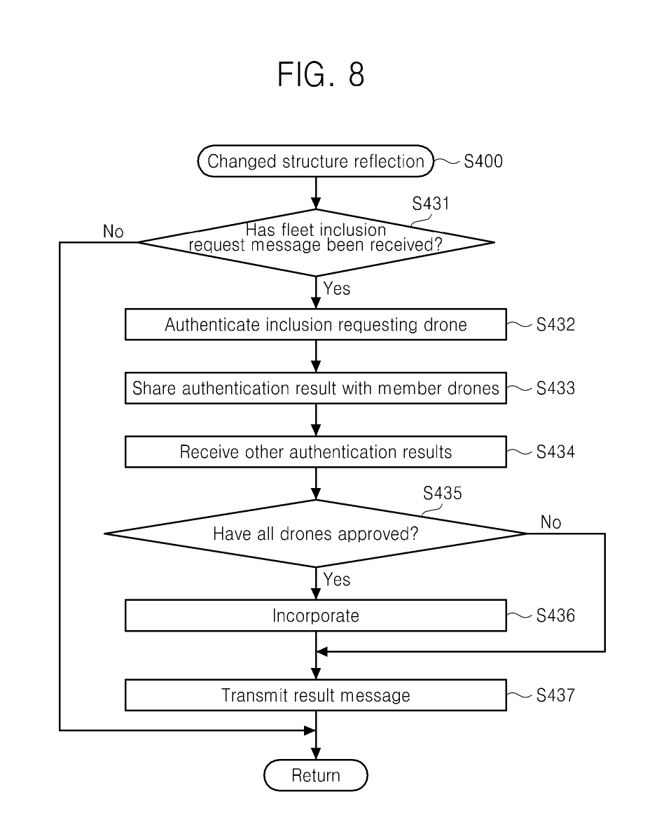

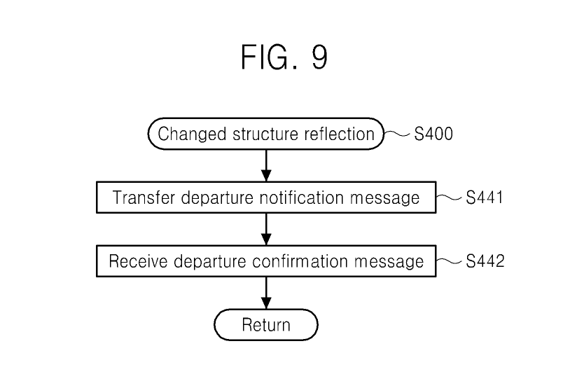

FIGS. 6 to 9 are schematic processing flowcharts illustrating a changed structure reflection process according to the first to third exemplary scenarios. FIG. 6 illustrates an example of a processing process in which the GCS 200 of FIG. 1A or the master drone 300 of FIG. 1B reflects a fleet structure changed due to the inclusion of a new drone according to the first and second exemplary scenarios. FIG. 7 illustrates an example of a processing process in which the GCS 200 of FIG. 1A, the master drone 300 of FIG. 1B, or one drone of the four drones 100a, 100b, 100c, and 100d constituting the fleet of FIG. 1C reflects a fleet structure changed due to the departure of a drone according to the first to third exemplary scenarios. On the other hand, FIG. 8 illustrates an example of a processing process in which one drone of the four drones 100a, 100b, 100c, and 100d constituting the fleet of FIG. 1C reflects a fleet structure changed due to the inclusion of a new drone. FIG. 9 illustrates an example of a processing process in which one drone of the four drones 100a, 100b, 100c, and 100d constituting the fleet of FIG. 1C reflects a fleet structure changed due to an ideal departure of a drone.

Referring to FIGS. 1A, 1B, and 6, in step S411, the GCS 200 of FIG. 1A or the master drone 300 of FIG. 1B determines whether a fleet inclusion request message is received from a new drone. When it is determined that the fleet inclusion request message is received in step S411, the new drone transmitting a fleet inclusion request message is registered in a pre-stored fleet list and added in step S412.

A scheme for the case in which an undesired drone is added in the above-described centralized control scheme is not handled in a protocol. This is because all drones are connected as single objects and easily authenticated using an existing scheme.

Referring to FIGS. 1A to 1C and 7, in step S421, the GCS 200 of FIG. 1A, the master drone 300 of FIG. 1B, and one drone of the four drones 100a, 100b, 100c, and 100d constituting the fleet of FIG. 1C periodically monitor a pre-registered fleet. This is for detecting the abnormal departure of the drone. An ultrasonic sensor, a camera, or the like may be used.

In step S422, it is determined whether the departure is detected as the monitoring result.

When the departure is detected in step S422, the GCS 200 of FIG. 1A, the master drone 300 of FIG. 1B, or one drone of the four drones 100a, 100b, 100c, and 100d constituting the fleet of FIG. 1C deletes a drone whose departure is detected from the fleet list pre-stored in each device in step S423.

Referring to FIGS. 1C and 8, in step S431, one drone (for example, the drone 100a) among the four drones 100a, 100b, 100c, and 100d constituting the fleet of FIG. 1C determines whether a fleet inclusion request message is received from a new drone. When it is determined that the fleet inclusion request message is received in step S431, the drone 100a authenticates the new drone transmitting the fleet inclusion request message in step S432.

In step S433, the drone 100a shares the authentication result with the other member drones 100b, 100c, and 100d. For this, the drone 100a transmits the authentication result to the other member drones 100b, 100c, and 100d. On the other hand, in step S434, the drone 100a receives authentication results of the other member drones 100b, 100c, and 100d for the new drone transmitting the above-described fleet inclusion request message. This is to reject the inclusion of the new drone when one or more drones discover a problem in authentication for the new drone, and accept the inclusion of the new drone only when all member drones approve the inclusion of the new drone, for security.

When it is determined that the new drone is approved by all the member drones in step S435, the new drone is incorporated in step S436 and a result message is transmitted to the new drone in step S437. In this case, in step S437, an inclusion success message is transmitted to the new drone. When it is determined that the new drone is not approved by all the member drones, that is, when the new drone is not authenticated by one or more drones, in step S435, a message indicating that the inclusion is rejected is transmitted in step S437.

Referring to FIGS. 1C and 9, in step S441, one drone (for example, the drone 100b) desiring to depart among the four drones 100a, 100b, 100c, and 100d constituting the fleet of FIG. 1C transfers a departure notification message to the peripheral drones (the drones 100a, 100c, and 100d in the example of FIG. 1C).

In step S442, the drone 100b receives departure confirmation messages from the peripheral drones 100a, 100c, and 100d having received the departure notification message. Because each drone has an independent determination algorithm in the case of the decentralized control scheme, each drone individually determines to depart from the fleet and notifies the peripheral drones of the departure.

Meanwhile, the exemplary solutions may be prepared by a program which is executable in a computer and implemented in a general-purpose digital computer operating the program by using a computer-readable recording medium.

The computer-readable recording medium includes magnetic storage media (e.g., a ROM, a floppy disk, a hard disk, and the like) and storage media such as optical reading media (e.g., a CD-ROM, a DVD, and the like).

The present invention has been described with reference to concrete examples. A person skilled in the art would understand that the present invention can be realized as a modified form within a scope not departing from the essential characteristics of the present invention. Accordingly, the disclosed examples must be considered in their illustrative aspect and not their limitative aspect. The scope of the present invention is shown not in the aforesaid explanation but in the appended claims, and all differences within a scope equivalent thereto should be interpreted as being included in the present invention.

What is claimed is:

1. A method in which a ground control station (GCS) controls a fleet of drones, the method comprising:
registering, by the GCS which is located on the ground, stores information about the drones, and controls the drones, all the drones constituting the fleet in a fleet list;
configuring the fleet by synchronizing a physical position and a logical position for each of all the registered drones;
controlling a form of the fleet based on a mission of the fleet or a peripheral environment having an influence on a flight of the fleet; and
maintaining the fleet by immediately reflecting inclusion or departure in fleet information when a drone constituting the fleet is incorporated into or departs from the fleet.

2. The method according to claim 1, wherein the configuring of the fleet includes:
receiving a plurality of sensor values from a plurality of sensors mounted on each of the registered drones and estimating the physical position of each of the registered drones; and
synchronizing the physical position and the logical position for each of the registered drones within the fleet.

3. The method according to claim 2,
wherein the plurality of sensors include a camera, an ultrasonic sensor, and an infrared sensor, and
wherein the logical position is estimated based on a round trip time of a sound through sound exchange with the registered drones.

4. The method according to claim 1, wherein the controlling of the form of the fleet includes:
determining a value of a distance between the drones constituting the fleet and a flight height of the drone by detecting a wind velocity around a position at which the fleet flies; and
determining an operating range of the entire fleet and the value of the distance between the drones constituting the fleet based on characteristics of the mission to be performed by the fleet.

5. The method according to claim 1, wherein the controlling of the form of the fleet includes:
predicting whether the fleet collides with a geographical feature based on geographical information prestored in the GCS and an estimated flight path of the fleet and changing the form of the fleet to prevent a collision according to a prediction result.

6. The method according to claim 1, wherein the controlling of the form of the fleet includes:
controlling the form of the fleet based on a prestored risk function algorithm to indicate real-time flight environment information of the fleet by a numerical value and indicate a degree of risk for a current fleet form according to the numerical value.

7. A method in which a master drone controls a fleet of drones, the method comprising:
transmitting, by the master drone which is one of the drones constituting the fleet, a discovery message to all member drones constituting the fleet;
configuring the fleet by receiving response messages from the member drones;
controlling a form of the fleet based on a mission of the fleet or a peripheral environment having an influence on a flight of the fleet; and
maintaining the fleet by immediately reflecting inclusion or departure in fleet information when a drone constituting the fleet is incorporated into or departs from the fleet.

8. The method according to claim 7, wherein the controlling of the form of the fleet includes:
controlling the drones to maintain a distance value by transferring the distance value between the drones determined based on a wind velocity detected by the master drone or characteristics of the mission to the drones which measure a mutual distance through mutual exchange of sensor values in control of the distance between the drones.

9. A method of controlling a fleet of drones, the method comprising:
registering, by a third drone which is any one of the drones constituting the fleet, all member drones constituting the fleet;
configuring, by the third drone, the fleet by synchronizing a physical position and a logical position for each of the member drones;
controlling, by the third drone, a form of the fleet based on a mission of the fleet or a peripheral environment having an influence on a flight of the fleet; and
maintaining, by the third drone, the fleet by immediately reflecting inclusion or departure in fleet information when a drone constituting the fleet is incorporated into or departs from the fleet.

10. The method according to claim 9, wherein the maintaining of the fleet including:
receiving, by the third drone, a fleet inclusion request message from a fourth drone which is a new drone;
authenticating, by the third drone, the fourth drone;
sharing, by the third drone, an authentication result with all member drones;
receiving, by the third drone, authentication results of all the member drones for the fourth drone; and
transmitting, by the third drone, a result message indicating an inclusion of the fourth drone to the fourth drone after the fourth drone is incorporated into the fleet when the third drone and all the other member drones approve the inclusion of the fourth drone in the fleet.
